(19) United States
(12) Patent Application Publication
(10) Pub. No.: US 2014/0301645 A1
(43) Pub. Date: Oct. 9, 2014

(54) METHOD AND APPARATUS FOR MAPPING A POINT OF INTEREST BASED ON USER-CAPTURED IMAGES

(71) Applicant: NOKIA CORPORATION, Espoo (FI)

(72) Inventor: Ville-Veikko Mattila, Tampere (FI)

(73) Assignee: Nokia Corporation, Espoo (FI)

(21) Appl. No.: 13/856,177

(22) Filed: Apr. 3, 2013

(51) Int. Cl. G06K 9/00

(52) U.S. Cl. CPC G06K 9/00476
USPC 382/182; 382/201

(57) ABSTRACT

An approach is provided for mapping a point of interest (POI) based on user-captured images. One or more user-captured images are queried based, at least in part, on a POI data record. One or more identifying features of a POI associated with the POI data record are recognized in the one or more user-captured images and a position of the one or more identifying features is determined in the one or more user-captured images. The POI is mapped based, at least in part, on the position of the one or more identifying features and image metadata associated with the one or more user-captured images.

### BACKGROUND

Service providers and device manufacturers (e.g., wireless, cellular, etc.) are continually challenged to deliver value and convenience to consumers by, for example, providing compelling network services. Users increasingly desire to obtain information about points of interest (POIs) when they access digital mapping services (e.g., Nokia Places®, Google Places®, etc.). The growing demand for consuming POI information via such services has led service providers to integrate the POI information (e.g., name, address, category, etc.) with mapping information. However, POIs are often mapped to specific locations inaccurately or unclearly because the POI data records associated with the POIs do not provide sufficiently detailed location information. For example, a POI data record may only map to a street address but not to a specific building or portion thereof (e.g., floor, suite, etc.). In addition, new POIs are often too new to be depicted in street level imagery used by the digital mapping services.

### SOME EXAMPLE EMBODIMENTS

Therefore, there is a need for an approach for mapping a point of interest based on user-captured images.

According to one embodiment, a method comprises causing, at least in part, a querying for one or more user-captured images based, at least in part, on a POI record. The method also comprises causing, at least in part, a recognition of one or more identifying features of a POI associated with the POI data record in the one or more user-captured images and determining a position of the of the one or more identifying features in the one or more user-captured images. The method further comprises causing, at least in part, a mapping of the POI based, at least in part, on the position of the one or more identifying features and image metadata associated with the one or more user-captured images.

According to another embodiment, an apparatus comprises at least one processor, and at least one memory including computer program code for one or more computer programs, the at least one memory and the computer program code configured to, with the at least one processor, cause, at least in part, the apparatus to query for one or more user-captured images based, at least in part, on a POI record. The apparatus is also caused to recognize one or more identifying features of a POI associated with the POI data record in the one or more user-captured images and determine a position of the of the one or more identifying features in the one or more user-captured images. The apparatus is further caused to map the POI based, at least in part, on the position of the one or more identifying features and image metadata associated with the one or more user-captured images.

According to another embodiment, a computer-readable storage medium carries one or more sequences of one or more instructions which, when executed by one or more processors, cause, at least in part, an apparatus to query for one or more user-captured images based, at least in part, on a POI record. The apparatus is also caused to recognize one or more identifying features of a POI associated with the POI data record in the one or more user-captured images and determine a position of the of the one or more identifying features in the one or more user-captured images. The apparatus is further caused to map the POI based, at least in part, on the position of the one or more identifying features and image metadata associated with the one or more user-captured images.

According to another embodiment, an apparatus comprises means for causing, at least in part, a querying for one or more user-captured images based, at least in part, on a POI record. The apparatus also comprises means for causing, at least in part, a recognition of one or more identifying features of a POI associated with the POI data record in the one or more user-captured images and determining a position of the of the one or more identifying features in the one or more user-captured images. The apparatus further comprises means for causing, at least in part, a mapping of the POI based, at least in part, on the position of the one or more identifying features and image metadata associated with the one or more user-captured images.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1A is a diagram of a system capable of mapping a POI based on user-captured images, according to one embodiment;

FIG. 1B is a diagram of a geographic database, such as can be included in the system of FIG. 1A, according to one embodiment;

FIG. 2 is a diagram of the components of POI mapping platform, according to one embodiment;

FIGS. 3A and 3B are flowcharts depicting processes for mapping a POI based on user-captured images, according to an embodiment;

FIGS. 4A-4D illustrate the processes of FIGS. 3A and 3B, by way of an exemplary use case scenario;

FIG. 5 is a diagram of a global coordinate system utilized in the processes of FIGS. 3A and 3B, according to one embodiment;

FIG. 6 is a diagram of a camera orientation in a three dimensional (3D) space utilized in the processes of FIGS. 3A and 3B, according to one embodiment;

FIG. 7 illustrates an example of a camera pose in a 3D Earth-Centered, Earth-Fixed Cartesian Coordinate System (CCS_{—}3D_ECEF) utilized in the processes of FIGS. 3A and 3B, according to one embodiment;

FIG. 8 is a diagram of hardware that can be used to implement an embodiment of the invention;

FIG. 9 is a diagram of a chip set that can be used to implement an embodiment of the invention; and

FIG. 10 is a diagram of a mobile terminal (e.g., handset) that can be used to implement an embodiment of the invention.

### DESCRIPTION OF SOME EMBODIMENTS

Examples of a method, apparatus, and computer program for mapping a POI based on user-captured images are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

As used herein, the term “POI mapping” refers to the association of a POI with one or more reference objects (e.g., buildings, structures, facilities, etc.). By way of example, this association may be indicated as a reference object identifier in a POI data record associated with the POI. An accurate POI mapping may be utilized by an application to indicate the POI in a street level map view or 3D model rendering of a location. It is contemplated that the POI-reference object association may be made at various levels of detail. For example, at a street address level of detail, the POI may be indicated as a point on the street. On the other hand, POI data records that include a building identifier may cause the POI to be mapped to a specific building. It is contemplated that a more detailed mapping may include the real-world coordinates of a particular section of a reference object. By way of example, a high-resolution mapping may map the same POI to a specific floor or other portion of the building actually occupied by the business.

Various augmented reality or mixed reality mapping applications aim to provide rich contextual information to their users. These applications may provide high-definition spherical street view panoramas as well as augmented reality experiences based on previously captured images and live or recorded video data. Such applications may employ remote sensing (e.g., light detection and ranging (LIDAR)) and motion tracking (e.g., inertial measurements units (IMUs)) technologies to create sophisticated geographic coordinate-tagged (“geotagged”) renderings of various objects (e.g., buildings) using 3D wire frame models and texture information. These technologies may also be used to register panoromas and captured images with real-world coordinate information (“registered images”) for association with other third-party images. POI information may be overlaid on such renderings to deliver a rich augmented or mixed reality user experience. However, users often find that the mapping of a newly released POI to a reference object is inaccurate or unclear. This may be because the metadata in the POI data record for the POI may only provide a street address and does not indicate the reference object identifier (e.g., building id). This affects the user experience because street addresses may not provide enough information to clearly indicate the reference object (e.g., building, transit facility, shopping store, etc.). Further, the registered street images used to generate building facades or other external surfaces of the reference objects may be too old to depict the POI associated with a newly released POI data record. This is particularly true in the case of commercial entities (e.g., new shops, restaurants, cafes, etc.). Thus, the user experience may further be affected because the registered images cannot be relied upon to accurately locate the POI either.

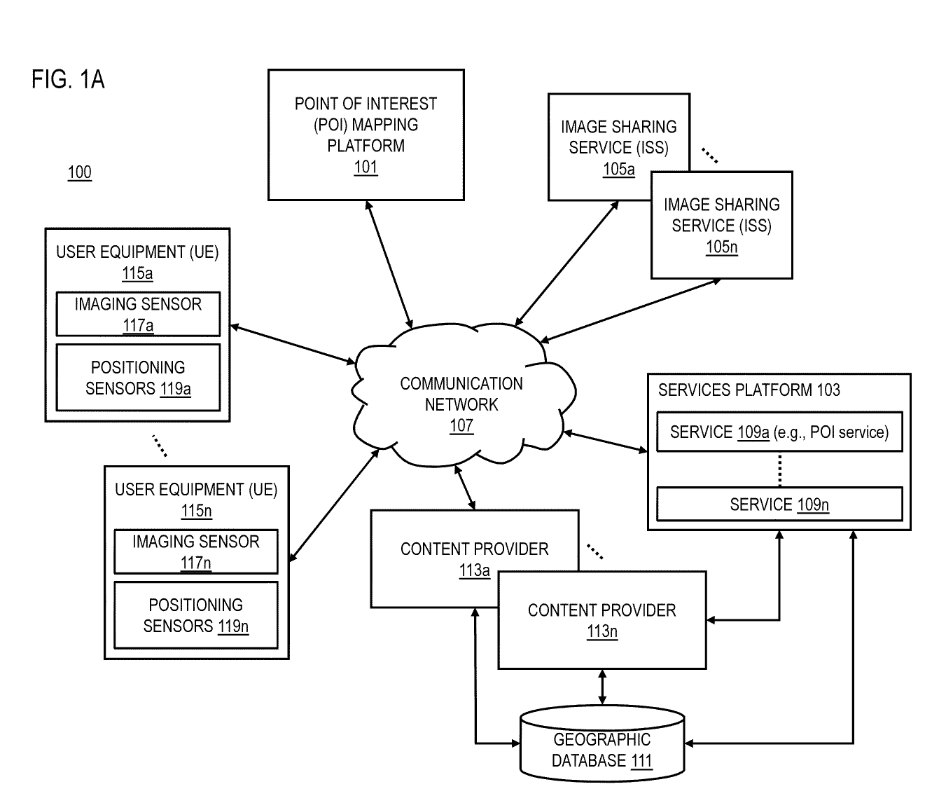

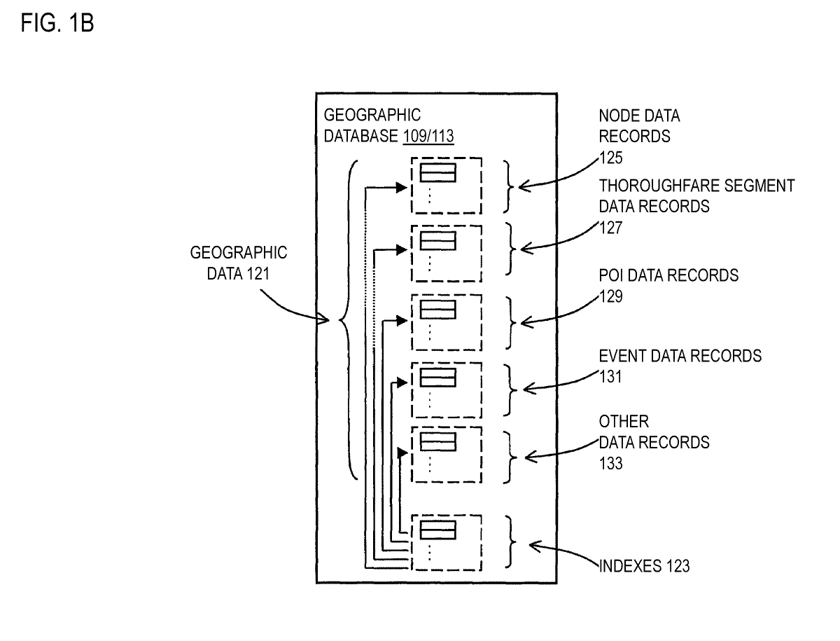

To address this problem, the system of FIG. 1A maps the POI based on user-captured images. The growth of mobile devices featuring high-resolution imaging sensors and the concurrent growth of media sharing sites has created large public repositories of geotagged, user-captured images. In one embodiment, the system 100 of FIG. 1A creates the POI mapping based on the position of one or more identifying features of the POI in user-captured images and metadata associated with these images. Because media sharing sites are constantly being updated by users, such sites provide more up-to-date street imagery than the registered images of map developers. In this way, the system allows mapping applications to accurately map POIs and overlay POI information regardless of how recently the POI data record was released. By way of example, the opening of a new restaurant may trigger the release of a new POI data record to the system of FIG. 1A. The POI data record may include the name of the restaurant and a street address, but it may lack a building identifier. The system of FIG. 1A provides the capability to determine a reference object identifier based on one or more user-captured images at or near the location of the POI. Continuing with our example, the system 100 may determine a building identifier for the restaurant and associate it with the restaurant's POI data record. Thereafter, service providers may utilize the building identifier to accurately depict the restaurant's location in a particular building.

As shown in FIG. 1A, the system 100 comprises a POI mapping platform 101 having connectivity to services platform 103 and one or more image sharing services 105a-105n (collectively referred to as image sharing services 105) via communication network 107. In one embodiment, services platform 103 includes one or more services 109a-109n (also collectively referred to as services 109) that provide service functions and/or content using information or data stored in one or more databases. In the case of location-based services, the one or more databases may include geographic database 111. In one embodiment, geographic database 111 is maintained by one or more content providers 113a-113n (also collectively referred to as content providers 113).

In one embodiment, services 109 include a POI service (e.g., POI service 109a). POI service 109a may provide, for example, a unified portal for all POI information as it becomes available. In one embodiment, POI service 109a may maintain one or more POI data records (not shown for illustrative convenience). The maintenance of POI data records may include the addition, modification or removal of POI data records in order to provide users an up-to-date POI database. In one embodiment, geographic databases 111 may also be POI databases. In one embodiment, an individual POI data record may include various record items, including a time of entry/creation/release, modification, update, etc. It is contemplated that the POI mapping platform 101 may query the POI service 109a to obtain the latest POI data records as they updated or released. In one embodiment, the POI mapping platform 101 queries the POI service 109a based on a time of update or release. Alternatively, the POI service 109a may communicate POI data records to the POI mapping platform 101 as the records are released or are updated. In one embodiment, the POI mapping platform 101 and the content providers 113 may communicate directly.

The POI mapping platform 101 may also have connectivity to the image sharing services 105 via communication network 107. The image sharing services 105 may be any third-party content provider hosting or otherwise storing user-captured images. The image sharing services 105 may include, for example, video sharing sites, photo sharing sites, social networking applications, as well as other online sharing communities to which images may be uploaded. As used herein, “user-captured images” may refer to any form of captured digital imagery that is publicly or commercially available. Image capturing may have been performed by any device equipped with image sensors, including various handheld and mobile devices (e.g., digital cameras, camcorders, camera-equipped Smartphones, etc.). By way of example, user-captured images may include both static and moving images (e.g., video) and imagery enhanced with varying levels of artificial augmentation (e.g., mixed reality (MR) images, augmented reality (AR) images).

In one embodiment, the system 100 also comprises user equipment (UE) 115a-115n (collectively referred to as UE 115) equipped with imaging sensors 117a-117n (collectively referred to as imaging sensors 117) and also having connectivity to the image sharing services 105 via communication network 107. In one embodiment, images captured by the UE may be sent to the image sharing services 105 for sharing with others. In one embodiment, the image sharing services 105 may make the images available to the public based on the privacy settings of individual users. For example, the image sharing services 105 may access a user profile database (not shown for illustrative convenience) to determine the level of privacy to be afforded to images uploaded by users.

The UE 115 may be any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 115 can support any type of interface to the user (such as “wearable” circuitry, etc.).

Each UE may also have operable thereon one or more positioning sensors 119a-119n (also collectively referred to as positioning sensors 119) for enabling the UE to detect a camera location and camera pose based on the location, orientation or movement of the UE. By way of example, the positioning sensors 119 are a positioning system that combines ultrasonic and inertial positioning sensors to detect changes in movement, position, orientation (e.g., tilt or skew). In certain embodiments, the inertial positioning sensors of the positioning sensors 119 are employed using gyroscopes, accelerometers and compass technology. Momentary positions and gestures are persistently calculated as well using the data collected by these devices.

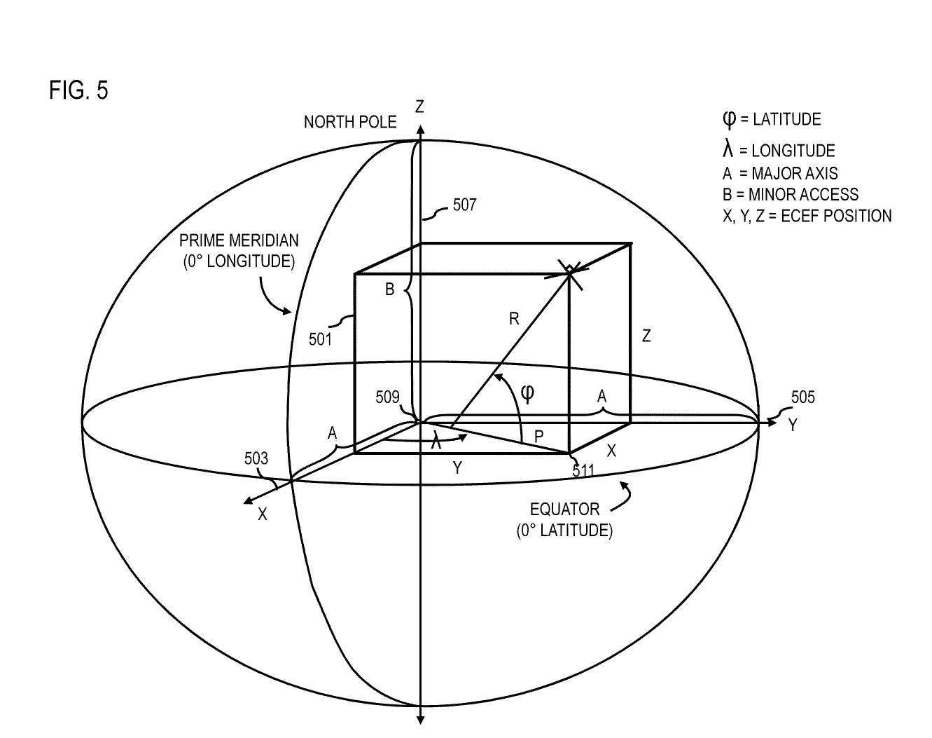

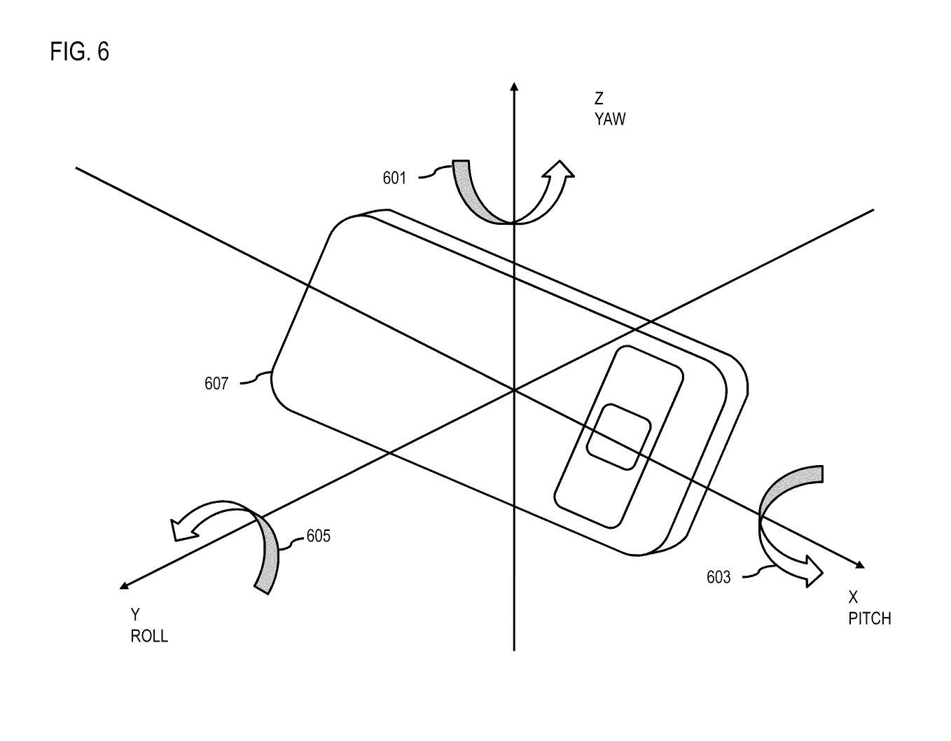

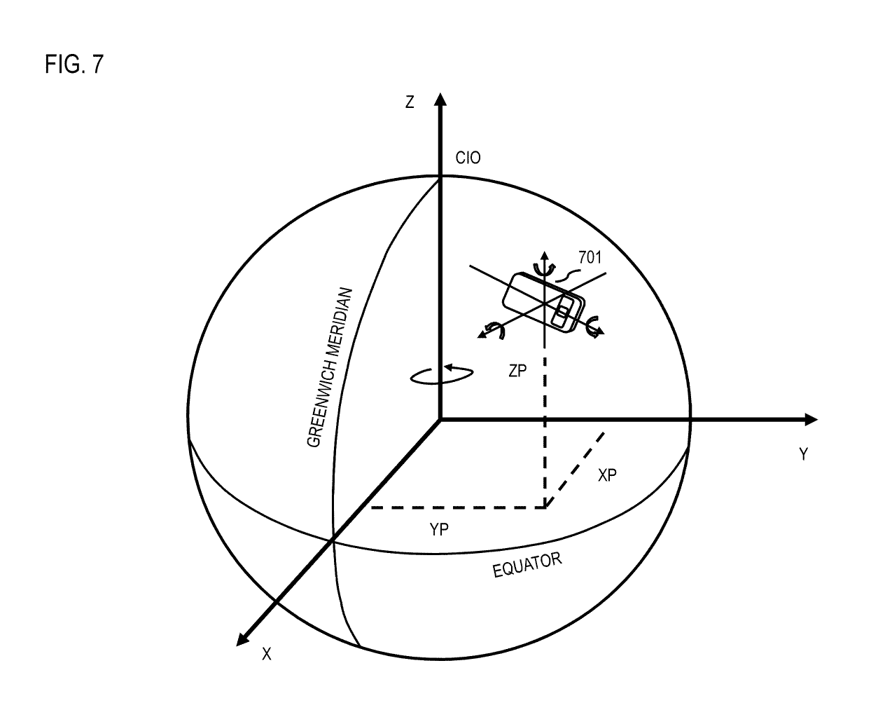

In one embodiment, the user-captured images are stored in files that may include metadata in their file headers, including a time of capture, positioning data, and camera pose information. By way of example, the image headers may store the metadata according to the exchangeable image file format (EXIF). In one embodiment, the UE geotags the images based on positioning information within a 3D Earth-Centered, Earth-Fixed Cartesian Coordinate System (CCS_{—}3D_ECEF) system (described in greater detail with respect to FIG. 5). The image metadata may also indicate camera pose information, including yaw, pitch and roll values (described in greater detail with respect to FIGS. 6-7).

Although various embodiments are described with respect to a POI mapping platform, it is contemplated that the approach described herein may be used with other decentralized or distributed components.

In one embodiment, the POI mapping platform 101 queries for user-captured images based on a POI data record. By way of example, the POI mapping platform 101 may query an image sharing service (e.g., image sharing service 105a) based on items (e.g., name, address, etc.) contained within the POI data record for a new POI (e.g., a new restaurant). In on embodiment, the image sharing service may be queried based on a time of capture, location, camera pose, and/or orientation, indicated by the image metadata. In one embodiment, the POI mapping platform 101 recognizes one or more identifying features in the user-captured images obtained from the image sharing services 105. By way of example, the POI mapping platform 101 may utilize a digital image processing technique to determine whether the image contains the identifying features. In one embodiment, the identifying features may include signs indicating a name, a symbol, a logo or other identifying feature of the POI. In one embodiment, the recognition of the identifying features is based on an optical character recognition (OCR) process and/or an image matching process. In one embodiment, the POI mapping platform 101 may compare the identifying features against reference identifying features stored in the POI data record to confirm the identifying features. In one embodiment, the POI mapping platform 101 determines a position of the identifying features in the user-captured images. By way of example, the position of a name of a restaurant as exhibited on a sign may be determined. In one embodiment, the POI is mapped based on the position of the identifying features and image metadata associated with the user-captured images. By way of example, the POI data record associated with the restaurant may be updated to include the reference object identifier of the building in which the restaurant is housed.

In one embodiment, the POI mapping platform 101 initiates the querying, the recognition and/or the mapping based on a determination of one or more updates to the POI data record. In one embodiment, the updates to a POI database may comprise an addition, a modification, or a deletion of the POI data record. As previously mentioned, entries in a POI database change relatively frequently compared to the rate at which registered street imagery is updated by map developers. By way of example, platform 101 may initiate querying when a new POI data record is released or when a POI content provider (e.g., content provider 113a) indicates to the POI mapping platform 101 that a new POI data record has been released. In one embodiment, the POI mapping platform 101 initiates the querying, the recognition and/or the mapping based on a determination that the POI is potentially visible in a street level mapping view. By way of example, the POI mapping platform 101 may examine whether the type (e.g., restaurant, cafë, office, hospital, etc.) of POI indicates that it may be visible outdoors in a street level mapping view before initiating the querying.

In one embodiment, POI mapping platform 101 determines a location and/or a time of release of the POI data record and/or the POI as criteria for the querying. The location and/or time of release may assist the POI matching process by narrowing the search for images to specific locations and time periods. By way of example, the location of a new restaurant and the time of release of its POI information may be used as criteria when querying one or more image sharing services 105.

In one embodiment, the POI mapping platform 101 processes the image metadata to determine a location, a camera pose, or a combination of one or more cameras capturing the user-captured images, performs a correlation of the position of the identifying features to building models based on the location and/or the camera pose and determines the mapping of the POI based on the correlation. By way of example, the location and camera pose information may be used to match the background of the user-captured image to one or more reference objects (e.g., building) in a 3D model of the location where the image was captured. Based on the position of the reference object (e.g., a shopping store), the position of the identifying features (e.g., a sign with the name of the shopping store) may be determined.

In one embodiment, the mapping of the POI is based on a global coordinate system. By way of example, the POI mapping platform 101 may utilize a CCS_{—}3D_ECEF coordinate system (described in greater detail with respect to FIG. 5) for the camera location and camera pose to query the image sharing services 105.

By way of example, the communication network 107 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

By way of example, the UE 115, POI mapping platform 101, image sharing services 105, services platform 103 and content providers 113 communicate with each other and other components of the communication network 107 using well known, new or still developing protocols. In this context, a protocol includes a set of rules defining how the network nodes within the communication network 107 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

FIG. 1B is a diagram of geographic database 111 of system 100, according to exemplary embodiments. In the exemplary embodiments, mapping data can be stored, associated with, and/or linked to the geographic database 111. In one embodiment, the geographic database 111 includes geographic data 121 used for (or configured to be compiled to be used for) mapping and/or navigation-related services, such as for personalized route determination, according to exemplary embodiments. In one embodiment, the geographic database 111 may include one or more indexes 123 for indexing the geographic data 121. By way of example, the geographic database 111 includes node data records 125, thoroughfare segment or link data records 127, POI data records 129, event data records 131, and other data records 133. More, fewer or different data records can be provided. In one embodiment, the other data records 133 include cartographic (“carto”) data records, routing data, and maneuver data. One or more portions, components, areas, layers, features, text, symbols, names and/or a time of release of the POI or event data can be stored in, linked to, and/or associated with one or more of these data records. For example, one or more portions of the POI, event data, or recorded route information can be matched with respective map or geographic records via position or GPS data associations (such as using known or future map matching or geo-coding techniques), for example. In one embodiment, the POI mapping platform 101 utilizes the name, location and a time of release of the POI data record for querying images of the POI from the image sharing services 105.

In exemplary embodiments, the thoroughfare segment data records 127 are links or segments representing roads, streets, or paths, as can be used in the calculated route or recorded route information for determination of one or more personalized routes, according to exemplary embodiments. The node data records 125 are end points corresponding to the respective links or segments of the thoroughfare segment data records 127. The thoroughfare segment data records 127 and the node data records 125 represent a thoroughfare network, such as used by vehicles and/or other entities (e.g., pedestrians, trains, planes, boats, etc.). Alternatively, the geographic database 111 can contain path segment and node data records or other data that represent pedestrian paths or areas in addition to or instead of the vehicle road record data, for example.

The thoroughfare/link segments and nodes can be associated with attributes, such as geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, shopping stores, parks, etc. The geographic database 111 can include data about the POIs and their respective locations in the POI data records 129. The geographic database 111 can also include data about places, such as cities, towns, or other communities, and other geographic features, such as bodies of water, mountain ranges, etc. Such place or feature data can be part of the POI data records 129 or can be associated with POIs or POI data records 129 (such as a data point used for displaying or representing a position of a city). In addition, the geographic database 111 can include event data (e.g., traffic incidents, construction locations, scheduled events, unscheduled events, etc.) associated with the POI data records 129 or other records of the geographic database 111.

The geographic database 111 can be maintained by the content provider 113 in association with the services platform 103 and/or content provider 113 (e.g., a map developer). The map developer can collect geographic data to generate and enhance the geographic database 111. There can be different ways used by the map developer to collect data. These ways can include obtaining data from other sources, such as municipalities or respective geographic authorities. In addition, the map developer can employ field personnel to travel by vehicle along roads throughout the geographic region to observe features and/or record information about them, for example. Also, remote sensing, such as aerial or satellite photography, can be used.

The geographic database 111 can be a master geographic database stored in a format that facilitates updating, maintenance, and development. For example, the master geographic database 111 or data in the master geographic database 111 can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF) format) to organize and/or configure the data for performing navigation-related functions and/or services, such as route calculation, route guidance, map display, speed calculation, distance and travel time functions, and other functions, by a navigation device, such as by a UE 115, for example. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases.

As mentioned above, the geographic database 111 can be a master geographic database, but in alternate embodiments, the client side geographic database (not shown for illustrative convenience) can represent a compiled navigation database that can be used in or with end user devices (e.g., UEs 115) to provide navigation-related functions. For example, the client side geographic database can be used with the UE 115 to provide an end user with navigation features. In such a case, the client side geographic database can be downloaded or stored on the end user device UE 115, or the end user device UE 115 can access the geographic database 111 and/or the client side geographic database through a wireless or wired connection (such as via a server and/or the communication network 107), for example.

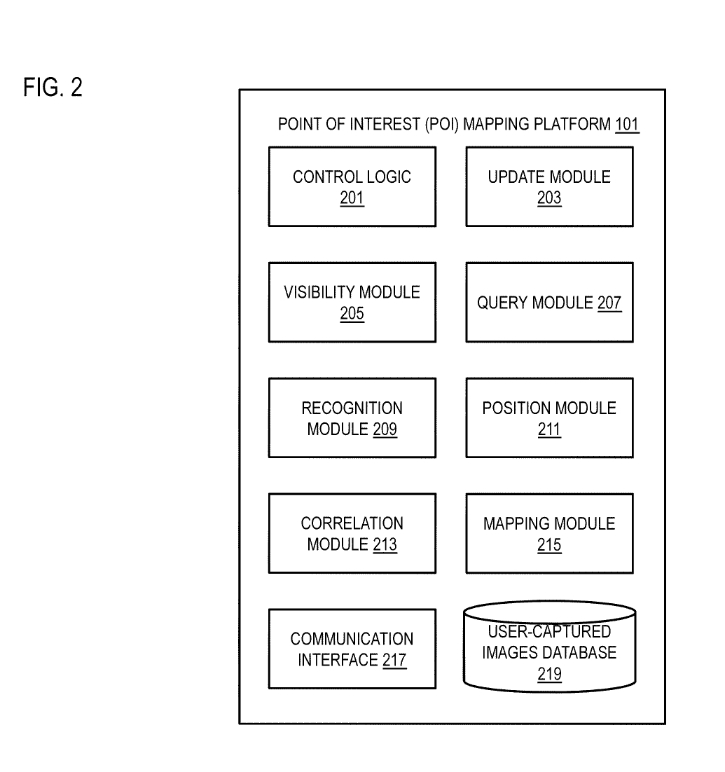

FIG. 2 is a diagram of the components of the POI mapping platform 101, according to one embodiment. By way of example, the POI mapping platform 101 includes one or more components for matching a POI based on user-captured images. It is contemplated that the functions of these components may be combined in one or more components or performed by other components of equivalent functionality. In this embodiment, the POI mapping platform 101 includes control logic 201, update module 203, visibility module 205, query module 207, recognition module 209, position module 211, correlation module 213, mapping module 215 and communication interface 217.

The control logic 201 oversees tasks, including tasks performed by the update module 203, visibility module 205, query module 207, recognition module 209, position module 211, correlation module 213, mapping module 215 and communication interface 217. For example, although the other modules may perform the actual task, the control logic 201 may determine when and how those tasks are performed or otherwise direct the other modules to perform the task.

The update module 203 may be used by control logic 201 to obtain, to cause to obtain, to retrieve or detect updates to a database or service maintaining POI data records. In one embodiment, POI mapping platform 101 may communicate with services platform 103 to obtain the information for a newly released POI data record 129 in geographic database 111. In another embodiment, the update module 203 may communicate with content providers 113 maintaining the geographic database 111. As previously mentioned, an update may include an addition, modification or removal of a POI data record. The update module 203 may parse the contents of an obtained POI data record and store them for further processing by other modules, including the query module 207 and the recognition module 209. In one embodiment, the update module 203 may add a reference object identifier to the POI data record 129 or indicate to the services platform 103 to add the reference object identifier after it has been determined by the POI mapping platform 101.

The visibility module 205 may be used by control logic 201 to determine whether the POI is potentially visible at a street level map view. In one embodiment, the visibility module 205 examines one or more items in the POI data record associated with the POI to determine the visibility of the POI in a street level map view. By way of example, shopping stores, cafës, restaurants, may be determined to be visible at a street level because these are frequently located to face passing by vehicular and pedestrian traffic. By further way of example, the visibility module 205 may employ lexical and semantic analysis tools, including information retrieval, data analytics and pattern recognition to generate various quantitative measures of potential visibility. In one embodiment, the results of visibility module 205 may be used by control logic 201 to determine whether to query the image sharing services 105. By way of example, if the visibility module 205 determines that a private restaurant is not visible at a street level view, control logic 201 may determine not to query the image sharing services 105.

The query module 207 may be used by control logic 201 to query the image sharing services 105. In one embodiment, the query module 207 queries the image sharing services 105 to obtain user-captured images based on information in the POI data record. In one embodiment, the query module 207 may utilize a location of the POI and a time of release of the POI data record to narrowly query the image sharing services 105 for any relevant images. By way of example, the query module 207 may use as its search criteria the location and time of release to obtain only those images that were captured after the POI became visible at a street level view and/or the POI data record was released. Query module 207 functions to effectuate a query via communication network 107 of the image sharing services 105. It is contemplated that query module 207 may also query any cached user-captured images located offline or via websites or services not expressly intended for image sharing. In one embodiment, the user-captured images retrieved or otherwise obtained by the query module 207 are stored at the user-captured images database 219 for further processing by the recognition module 209, position module 211 and the correlation module 213.

The recognition module 209 may be used to recognize in the user-captured images one or more identifying features of the POI indicated by its POI data record. In one embodiment, the recognition module 209 examines the user-captured images queried from the image sharing services 105 by the query module 207. The recognition module 209 may perform an initial preprocessing of the user-captured images to improve feature recognition, including de-skewing (correction to the image alignment), de-speckle (removal of blemishes or spots), binarization (conversion from color to grayscale), line removal, as well as correcting or otherwise taking into account any perspective effects. In one embodiment, the identifying features may include characters or text (cursive or non-cursive), symbols, logos or trademarks associated with a POI.

In one embodiment, the recognition module 209 may employ an OCR technique to recognize the name of the POI (e.g., restaurant, cafë, shopping store, etc.). In one embodiment, the recognition module 209 may employ various image matching or pattern recognition techniques to recognize the identifying features (e.g., logo, symbol). By way of example, the recognition module 209 may match the user-captured images to third-party images to recognize the identifying features. Image matching techniques may be useful if the identifying feature is a symbol, a company logo or artistically rendered text. In one embodiment, the POI data record may include a symbol, logo, or other non-textual identifier that the recognition module 209 may utilize to locate an identifying feature in the user-captured images. The identifying features are not limited to those indicated by the POI data record. In one embodiment, the recognition module 209 may recognize identifying features found in a website or online database. By way of example, the recognition module 209 may recognize a restaurant logo in a user-captured image based on a logo extracted from a website for the restaurant.

The position module 211 manages and controls determination of position information associated with the identifying features in the user-captured images. In one embodiment, the position module 211 causes to processes the image metadata of the user-captured images to determine the location and the camera pose for the cameras that were used to obtain the user-captured images and then causes to determine a correlation of the position of the identifying features to building models based on the location and the camera pose.

In one embodiment, the image metadata for the user-captured images obtained from the image sharing services 105 contains camera location and camera pose information. The image metadata may indicate the location information in a global coordinate system. By way of example, these coordinates may correspond to the latitude, longitude, and altitude elements according to a global positioning system (e.g., GPS, GNSS, GLONASS, etc.). The image metadata may also include a direction in which the camera was pointing at the time of image capture. In one embodiment, the image metadata may also indicate the camera pose at the time of image capture, including the camera orientation in a 3D space (e.g., Yaw, Pitch, Roll) that defines the camera movement with six degrees of freedom (6 DoF). The camera location and pose information as it may be obtained is further described with respect to FIGS. 5-7. As previously mentioned, the image metadata may be stored in the header of the image according to various specifications (e.g., EXIF).

In one embodiment, the position module 211 uses the correlation module 213 to determine a correlation of the position of the identifying features to building models based on the location and the camera pose. The correlation module 213 may overlay the camera location and pose information on a 3D wireframe model and map it to the location depicted by the user-captured images. By way of example, the correlation module 213 may compare the background of the user-captured images to one or more reference objects in the 3D model and determine a match to one of the reference objects based on the degree of correlation. As used herein, correlation may refer to any form of manual or automated image processing for determining a quantitative or qualitative measure of the degree of likeness between two images. By way of example, a high degree of correlation may be expected to be seen if a building in the wireframe model corresponds to a building depicted in the user-captured images. Conversely, a low degree of correlation may be expected if the building is not represented by a reference object in the 3D model. By further way of example, a 3D wireframe model of a city map may be used to determine the correlation. In one scenario, the possible use of a magnetometer (compass) integrated in a UE (e.g., UE 115a) can help in determining the direction the user is facing and thus help match the city map overlay with the location selected.

Based on the degree of correlation to a reference object in the 3D model, the position module 211 may determine the position of the identifying features as corresponding to the position of the reference object in the model. In one embodiment, the correlation module 213 may indicate to the position module 211 a reference object identifier or other positioning information for any reference object (e.g., buildings) depicted by the user-captured images based on the correlation.

The control logic 201 may use the mapping module 215 to add the identifier of the reference object that the identifying features correlate to in the POI data record. In one embodiment, the mapping module 215 updates the POI database via a POI information service (e.g., POI service 109a) to update the geographic database 111.

The communication interface 217 manages and controls any incoming and outgoing communication such as image and element analysis, data sharing from the image sharing services 105, content providers 113, services platform 103, and/or the services 109. The communication interface 217 can also manage other communications of the POI mapping platform 101 such as internet communications.

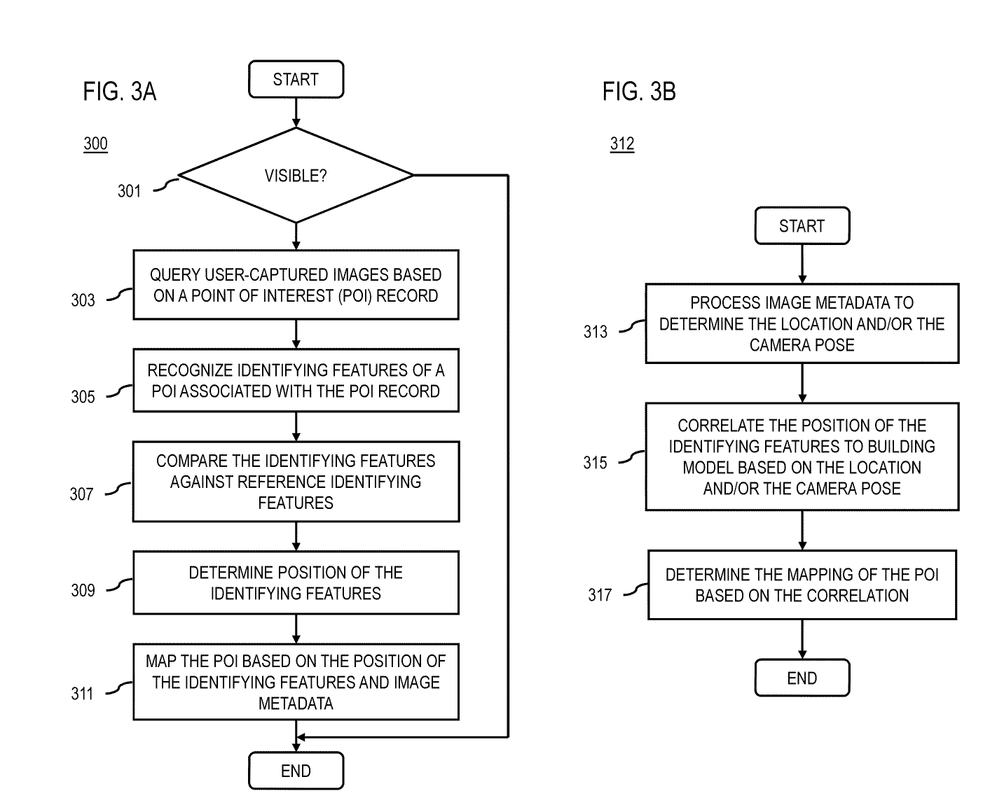

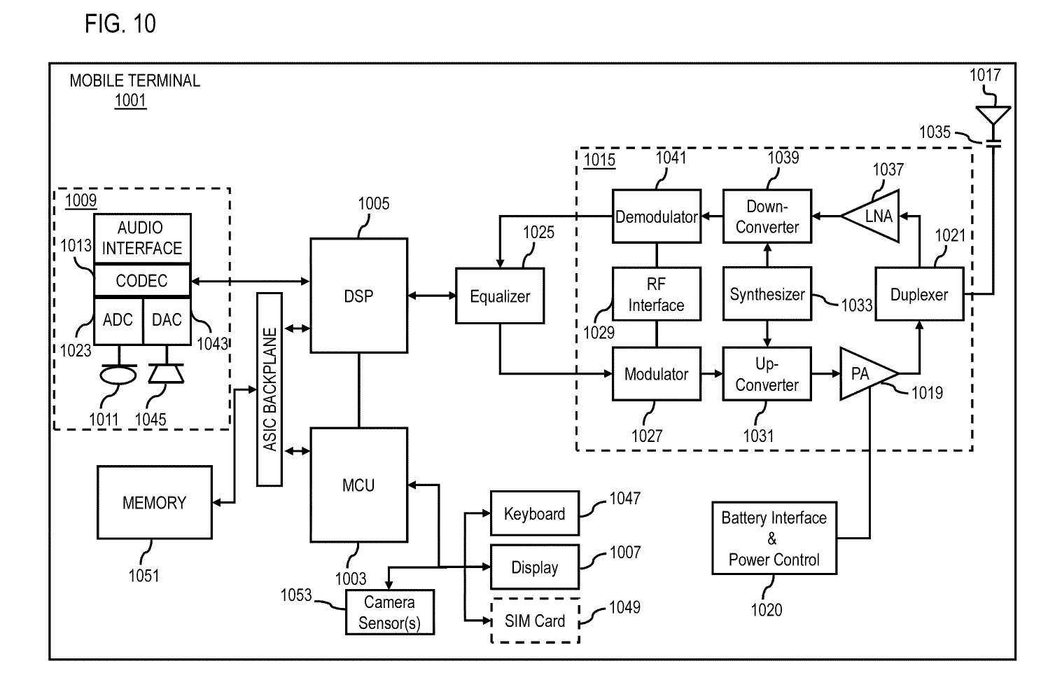

FIG. 3A is a flowchart of a process 300 for POI matching based on user-captured images, according to one embodiment. In one embodiment, the control logic 201, visibility module 205, recognition module 209, query module 207, position module 211, correlation module 213, and mapping module 215 in FIG. 2 perform the process 300 and are implemented in, for instance, a chip set including a processor and a memory as shown in FIG. 10.

In step 301, the POI mapping platform 101 determines whether the POI is potentially visible in a street level mapping view. By way of example, the platform may parse the contents of the POI data record for information indicative of street level visibility, including the name, category (e.g., restaurant, cafë) and address or location of the POI. The POI mapping platform 101 may employ lexical and semantic analysis tools, including information retrieval, data analytics and pattern recognition to generate various quantitative measures of potential visibility. If the POI mapping platform 101 determines that the POI is potentially visible, process 300 proceeds to step 303; otherwise, process 300 terminates.

In step 303, the POI mapping platform 101 queries for one or more user-captured images based on the POI data record. In one embodiment, the platform may initiate the querying based on an update to a POI database. By way of example, the POI mapping platform 101 may receive the information of a new POI via a POI service (e.g., POI service 109a) and a POI database (e.g., geographic database 111). Based on one or more items of the POI data record, the POI mapping platform 101 may query one or more image sharing services (e.g., image sharing services 105) to retrieve images corresponding to the location and time of release of the POI. In one embodiment, the retrieved images may be stored locally at the POI mapping platform 101 for further processing in subsequent steps of the process 300.

In step 305, the POI mapping platform 101 causes recognition of one or more identifying features of the POI associated with the POI data record in the user-captured images. In one embodiment, the identifying features of the POI may include a name or a symbol associated with the POI. The POI mapping platform 101 may employ various image analysis and processing techniques to recognize the name or symbol of the POI in the user-captured images. In step 307, any identifying features recognized by the POI mapping platform 101 may be compared to reference identifying features for confirmation.

In step 309, the POI mapping platform 101 determines the position of the identifying features in the user-captured images. In one embodiment, the position of the identifying features is determined in a global coordinate system (e.g., CCS_{—}3D_ECEF described in FIG. 5). By way of example, the position of the identifying features in the user-captured images may be used to map to a reference object in a 3D model (e.g., city model) of the location where the image was captured. In one embodiment, the POI mapping platform 101 maps the POI to the reference object by adding the reference object identifier to the POI data record for the POI (step 311).

FIG. 3B is a flowchart of a process 312 for determining the position of the identifying features of the user-captured images, according to one embodiment. In one embodiment, process 312 may be performed during step 309 of process 300. In one embodiment, the position module 211 performs the process 312 and is implemented in, for instance, a chip set including a processor and a memory as shown in FIG. 10.

In step 313, the POI mapping platform 101 processes the image metadata to determine a camera location and a camera pose of the camera capturing the user-captured images. In one embodiment, the image metadata may comprise information in the image file header, including the location where the image was captured, camera direction, and camera pose. In step 315, the POI mapping platform 101 causes a correlation of the position of the identifying features to one or more building models based on the location and pose information. In one embodiment, the POI mapping platform 101 may utilize a 3D wireframe model of the location to correlate the identifying features to one or more structures based on various image processing and analysis techniques. Based on the results of the correlation, the POI mapping platform 101 determines a mapping of the POI based on the identifier of the reference object in the model (step 317).

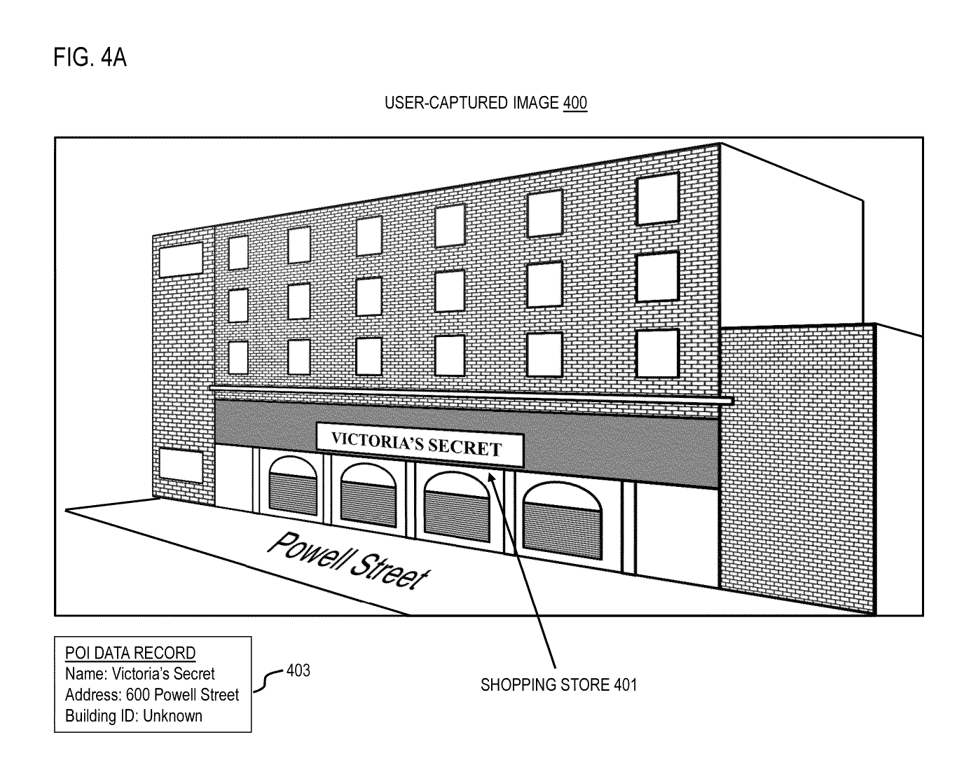

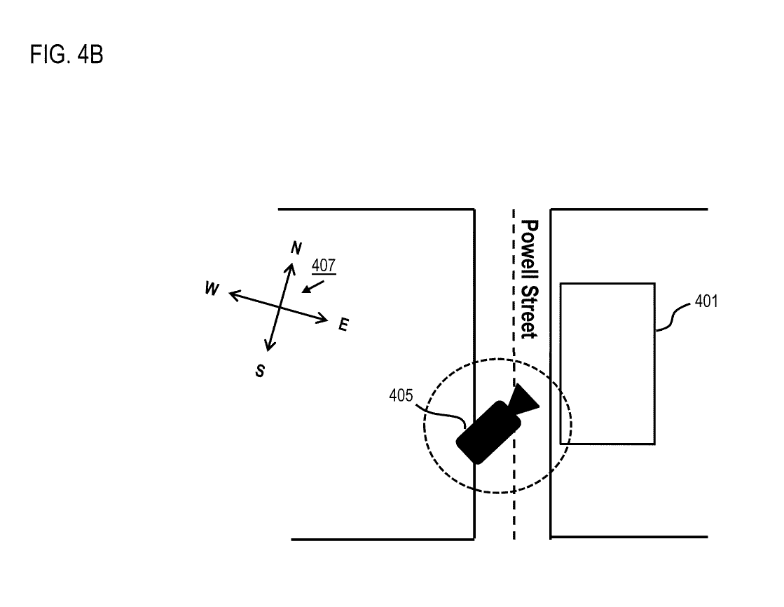

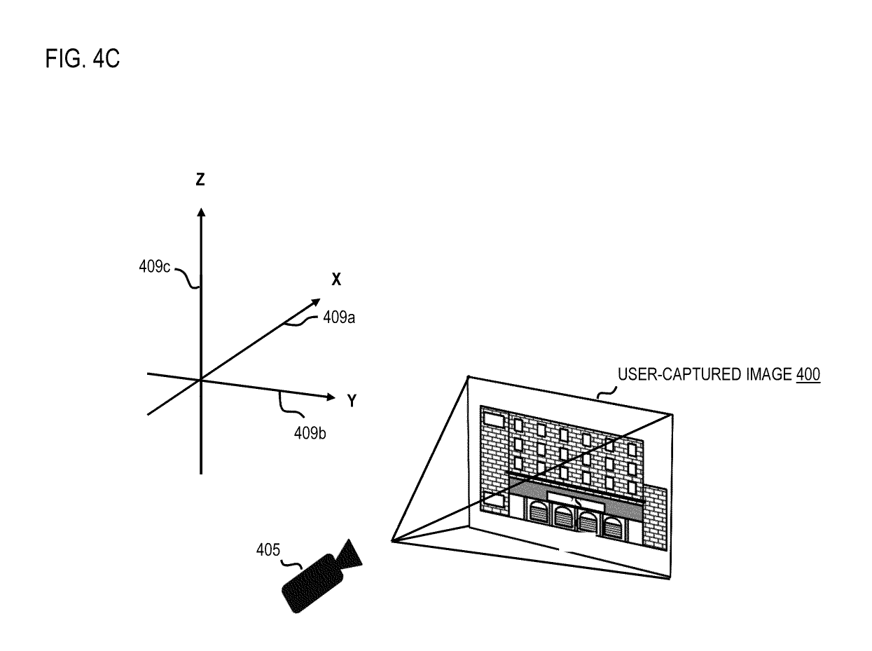

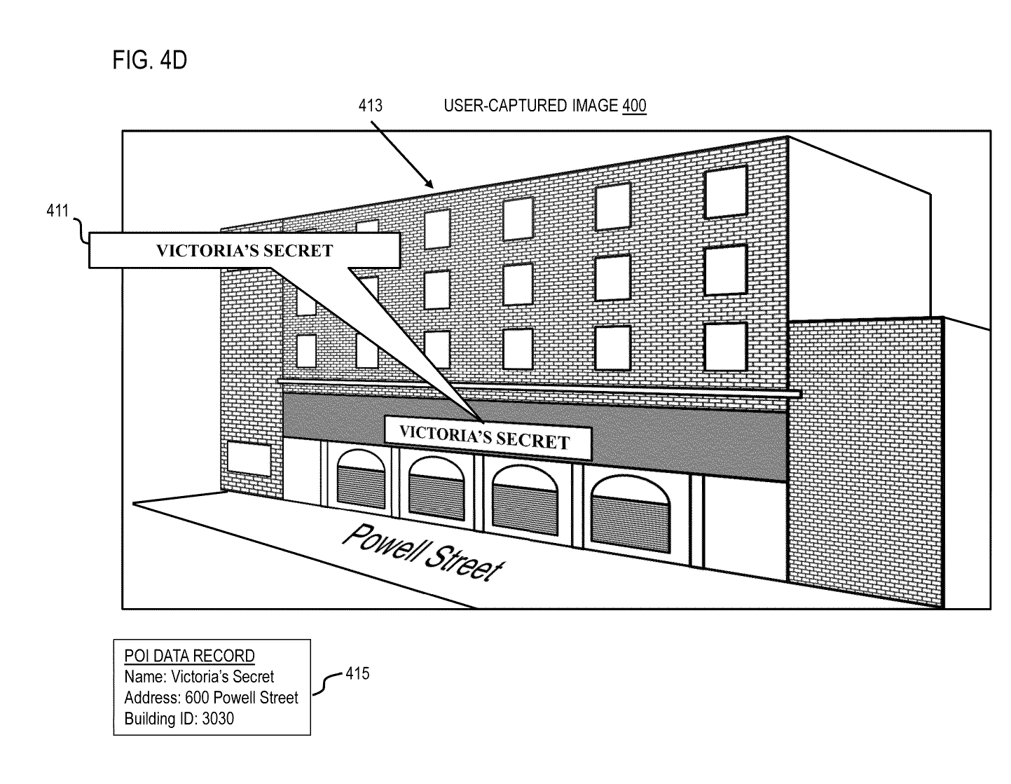

FIGS. 4A-4D illustrate the processes of FIGS. 3A and 3B, by way of an exemplary use case scenario. FIG. 4A illustrates a user-captured image 400 of a new shopping store 401 (“Victoria's Secret”) taken from outside the store at a street level view. By way of example, the user-captured image 400 may have been made available to the general public via one or more image sharing services (e.g., image sharing services 105 in FIG. 1A). In one scenario, the shopping store may have opened its doors for business recently. At the time of the opening, a POI data record 403 for the shopping store may have been added to a POI database (e.g., geographic database 111 in FIG. 1). As indicated in FIG. 4A, the building identifier information may not be indicated by the released POI data record 403 for the store. As previously mentioned, the street level imagery for a street level view or 3D model mapping application may not have been updated at the time of the opening of the shopping store 401. Therefore, mapping applications may not be able to overlay store information (not shown for illustrative convenience) contained in the POI data record 403 when presenting or rendering the street level view of the shopping store 401.

FIG. 4B illustrates a map view of the location from where the user-captured image 400 was captured by a user. As shown, the camera 405 used to capture the image 400 of the shopping store 401 is oriented in a north easterly direction with respect to the compass 407. In one embodiment, the POI mapping platform 101 determines the location and direction information for the camera 405 based on positioning information (e.g., GPS) in the header of the image file (not shown for illustrative convenience) for the user-captured image 400.

FIG. 4C illustrates a camera pose for the camera 405 used to capture the image 400, according to one embodiment. As shown, the camera 405 used to capture the image 400 is posed with respect to X, Y, and Z coordinate axes 409a, 409b, and 409c, respectively. The POI mapping platform 101 may utilize the name of the shopping store (“Victoria's Secret”) as the identifying feature. Adverting to FIG. 4D, the POI mapping platform 101 may recognize the store sign 411 in the user-captured image 400 by OCR (or an image matching process) and then correlate the building 413 in the image 400 to a façade in a 3D model (not shown for illustrative convenience) of the location (e.g., Powell Street) to obtain the building identifier. In one embodiment, the POI mapping platform 101 may then add the building identifier (e.g., 3030) to produce the updated POI data record 415 for the shopping store.

FIG. 5 is a diagram of a global coordinate system utilized in the process of FIGS. 3A and 3B, according to one embodiment. The earth surface is often approximated by a spherical model as illustrated in FIG. 5. Latitude (501) and longitude (503) are geographic coordinates that respectively specify the north to south position and east to west position of a point on earth surface. Such two dimensional geographic coordinate system enables every location on earth to be specified by a pair of latitude (501) and longitude (503), for instance, diagram 507 presents an example of a point P (505) (N 40°, W 60°) in a 2D geographic coordinate system (GCS 2D). In one scenario, if the height (509) of a geographic location is of interest, a triple of latitude, longitude and altitude (or elevation) can be used to represent a location that resides below, on or above earth surface, for instance, N 40°, W 60°, H 100 meters, wherein the height is defined as the distance between the point in question and a reference geodetic datum. The choice of the actual reference datum is defined by the geodetic system under consideration. For instance, the commonly used World Geodetic system (WGS 84) uses an elliptical datum surface and Earth Gravitational Model 1996 (EGM 96) geo-id for this purpose.

FIG. 6 is a diagram of a camera orientation in a 3D space utilized in the processes of FIGS. 3A and 3B, according to one embodiment. Here, Yaw (601) is a counterclockwise rotation along the z axis, Pitch (603) is a counterclockwise rotation along the y axis, and roll (605) is a counterclockwise rotation along the x axis. In one scenario, the video frames are often regarded as a sequence of still images that are captured (or displayed) at different time at varying camera locations. In one scenario, the camera pose of associated videos frames represent 3D locations and orientations of the video-capturing-camera at the time when the video frames were recorded. The camera locations can be simply described as X_{L}, Y_{L}, Z_{L}. The orientation can be described as roll, yaw and pitch angles of rotating the camera from a reference placement to its current placement. Further, the orientation can be represented by rotation matrices or quaternions, which are mathematically equivalent to Euler angles. With the camera location and orientation, one can define the camera movement with 6 DoF in a coordinate system.

FIG. 7 illustrates an example of a camera pose in CCS_{—}3D_ECEF utilized in the process of FIGS. 3A and 3B, according to one embodiment. In one scenario, a point cloud is a set of 3D points that are viewable from one or more image frames, when viewed from a given camera pose (701), 3D points are projected, according to proper camera models, onto the 2D image and gives rise to color intensities at different pixel locations. In the context of Earth modeling, 3D point clouds can be directly measured by LIDAR technology. Alternatively, 3D point clouds can be reconstructed from input video frames by using computer vision Structure-From-Motion (SFM) technology.

The processes described herein for POI mapping based on user-captured images may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

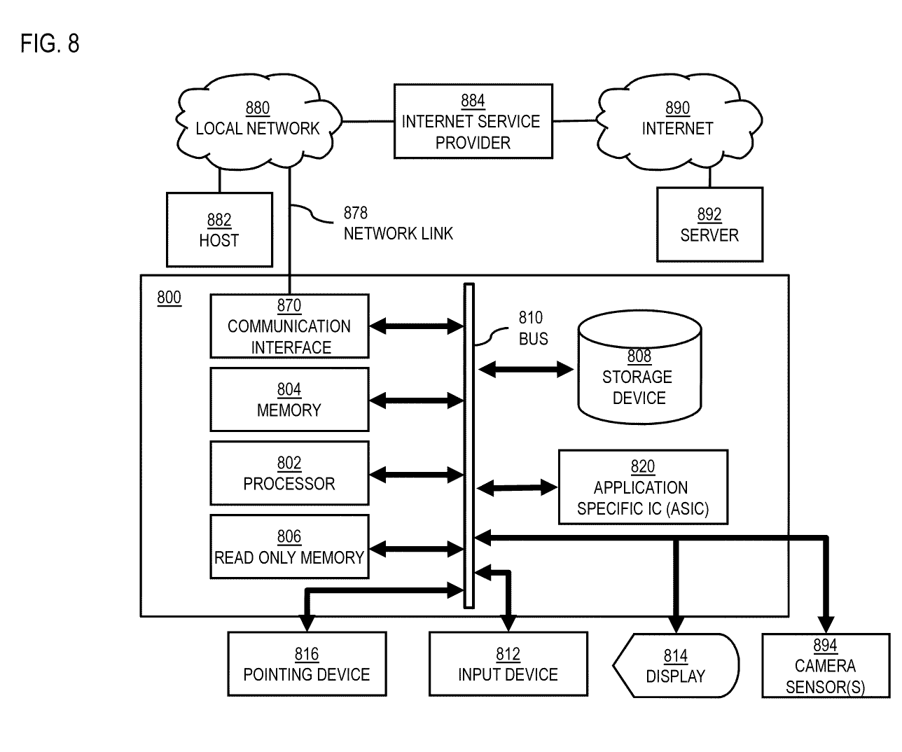

FIG. 8 illustrates a computer system 800 upon which an embodiment of the invention may be implemented. Although computer system 800 is depicted with respect to a particular device or equipment, it is contemplated that other devices or equipment (e.g., network elements, servers, etc.) within FIG. 8 can deploy the illustrated hardware and components of system 800. Computer system 800 is programmed (e.g., via computer program code or instructions) to map a POI based on user-captured images as described herein and includes a communication mechanism such as a bus 810 for passing information between other internal and external components of the computer system 800. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 800, or a portion thereof, constitutes a means for performing one or more steps of mapping a POI based on user-captured images.

A bus 810 includes one or more parallel conductors of information so that information is transferred quickly among devices coupled to the bus 810. One or more processors 802 for processing information are coupled with the bus 810.

A processor (or multiple processors) 802 performs a set of operations on information as specified by computer program code related to map a POI based on user-captured images. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 810 and placing information on the bus 810. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 802, such as a sequence of operation codes, constitute processor instructions, also called computer system instructions or, simply, computer instructions. Processors may be implemented as mechanical, electrical, magnetic, optical, chemical, or quantum components, among others, alone or in combination.

Computer system 800 also includes a memory 804 coupled to bus 810. The memory 804, such as a random access memory (RAM) or any other dynamic storage device, stores information including processor instructions for mapping a POI based on user-captured images. Dynamic memory allows information stored therein to be changed by the computer system 800. RAM allows a unit of information stored at a location called a memory address to be stored and retrieved independently of information at neighboring addresses. The memory 804 is also used by the processor 802 to store temporary values during execution of processor instructions. The computer system 800 also includes a read only memory (ROM) 806 or any other static storage device coupled to the bus 810 for storing static information, including instructions, that is not changed by the computer system 800. Some memory is composed of volatile storage that loses the information stored thereon when power is lost. Also coupled to bus 810 is a non-volatile (persistent) storage device 808, such as a magnetic disk, optical disk or flash card, for storing information, including instructions, that persists even when the computer system 800 is turned off or otherwise loses power.

Information, including instructions for mapping a POI based on user-captured images, is provided to the bus 810 for use by the processor from an external input device 812, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 800. Other external devices coupled to bus 810, used primarily for interacting with humans, include a display device 814, such as a cathode ray tube (CRT), a liquid crystal display (LCD), a light emitting diode (LED) display, an organic LED (OLED) display, a plasma screen, or a printer for presenting text or images, and a pointing device 816, such as a mouse, a trackball, cursor direction keys, or a motion sensor, for controlling a position of a small cursor image presented on the display 814 and issuing commands associated with graphical elements presented on the display 814, and one or more camera sensors 894 for capturing, recording and causing to store one or more still and/or moving images (e.g., videos, movies, etc.) which also may comprise audio recordings. In some embodiments, for example, in embodiments in which the computer system 800 performs all functions automatically without human input, one or more of external input device 812, display device 814 and pointing device 816 may be omitted.

In the illustrated embodiment, special purpose hardware, such as an application specific integrated circuit (ASIC) 820, is coupled to bus 810. The special purpose hardware is configured to perform operations not performed by processor 802 quickly enough for special purposes. Examples of ASICs include graphics accelerator cards for generating images for display 814, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 800 also includes one or more instances of a communications interface 870 coupled to bus 810. Communication interface 870 provides a one-way or two-way communication coupling to a variety of external devices that operate with their own processors, such as printers, scanners and external disks. In general the coupling is with a network link 878 that is connected to a local network 880 to which a variety of external devices with their own processors are connected. For example, communication interface 870 may be a parallel port or a serial port or a universal serial bus (USB) port on a personal computer. In some embodiments, communications interface 870 is an integrated services digital network (ISDN) card or a digital subscriber line (DSL) card or a telephone modem that provides an information communication connection to a corresponding type of telephone line. In some embodiments, a communication interface 870 is a cable modem that converts signals on bus 810 into signals for a communication connection over a coaxial cable or into optical signals for a communication connection over a fiber optic cable. As another example, communications interface 870 may be a local area network (LAN) card to provide a data communication connection to a compatible LAN, such as Ethernet. Wireless links may also be implemented. For wireless links, the communications interface 870 sends or receives or both sends and receives electrical, acoustic or electromagnetic signals, including infrared and optical signals, that carry information streams, such as digital data. For example, in wireless handheld devices, such as mobile telephones like cell phones, the communications interface 870 includes a radio band electromagnetic transmitter and receiver called a radio transceiver. In certain embodiments, the communications interface 870 enables connection to the communication network 107 for mapping a POI based on user-captured images to the UE 115.

The term “computer-readable medium” as used herein refers to any medium that participates in providing information to processor 802, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 808. Volatile media include, for example, dynamic memory 804. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 820.

Network link 878 typically provides information communication using transmission media through one or more networks to other devices that use or process the information. For example, network link 878 may provide a connection through local network 880 to a host computer 882 or to equipment 884 operated by an Internet Service Provider (ISP). ISP equipment 884 in turn provides data communication services through the public, world-wide packet-switching communication network of networks now commonly referred to as the Internet 890.

A computer called a server host 892 connected to the Internet hosts a process that provides a service in response to information received over the Internet. For example, server host 892 hosts a process that provides information representing video data for presentation at display 814. It is contemplated that the components of system 800 can be deployed in various configurations within other computer systems, e.g., host 882 and server 892.

At least some embodiments of the invention are related to the use of computer system 800 for implementing some or all of the techniques described herein. According to one embodiment of the invention, those techniques are performed by computer system 800 in response to processor 802 executing one or more sequences of one or more processor instructions contained in memory 804. Such instructions, also called computer instructions, software and program code, may be read into memory 804 from another computer-readable medium such as storage device 808 or network link 878. Execution of the sequences of instructions contained in memory 804 causes processor 802 to perform one or more of the method steps described herein. In alternative embodiments, hardware, such as ASIC 820, may be used in place of or in combination with software to implement the invention. Thus, embodiments of the invention are not limited to any specific combination of hardware and software, unless otherwise explicitly stated herein.

The signals transmitted over network link 878 and other networks through communications interface 870, carry information to and from computer system 800. Computer system 800 can send and receive information, including program code, through the networks 880, 890 among others, through network link 878 and communications interface 870. In an example using the Internet 890, a server host 892 transmits program code for a particular application, requested by a message sent from computer 800, through Internet 890, ISP equipment 884, local network 880 and communications interface 870. The received code may be executed by processor 802 as it is received, or may be stored in memory 804 or in storage device 808 or any other non-volatile storage for later execution, or both. In this manner, computer system 800 may obtain application program code in the form of signals on a carrier wave.

Various forms of computer readable media may be involved in carrying one or more sequence of instructions or data or both to processor 802 for execution. For example, instructions and data may initially be carried on a magnetic disk of a remote computer such as host 882. The remote computer loads the instructions and data into its dynamic memory and sends the instructions and data over a telephone line using a modem. A modem local to the computer system 800 receives the instructions and data on a telephone line and uses an infra-red transmitter to convert the instructions and data to a signal on an infra-red carrier wave serving as the network link 878. An infrared detector serving as communications interface 870 receives the instructions and data carried in the infrared signal and places information representing the instructions and data onto bus 810. Bus 810 carries the information to memory 804 from which processor 802 retrieves and executes the instructions using some of the data sent with the instructions. The instructions and data received in memory 804 may optionally be stored on storage device 808, either before or after execution by the processor 802.

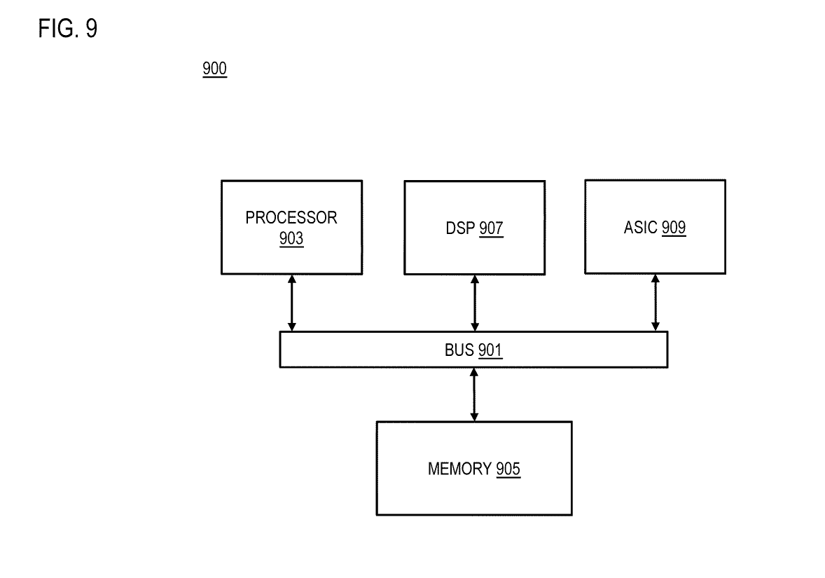

FIG. 9 illustrates a chip set or chip 900 upon which an embodiment of the invention may be implemented. Chip set 900 is programmed to map a POI based on user-captured images as described herein and includes, for instance, the processor and memory components described with respect to FIG. 8 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 900 can be implemented in a single chip. It is further contemplated that in certain embodiments the chip set or chip 900 can be implemented as a single “system on a chip.” It is further contemplated that in certain embodiments a separate ASIC would not be used, for example, and that all relevant functions as disclosed herein would be performed by a processor or processors. Chip set or chip 900, or a portion thereof, constitutes a means for performing one or more steps of providing user interface navigation information associated with the availability of functions. Chip set or chip 900, or a portion thereof, constitutes a means for performing one or more steps of mapping a POI based on user-captured images.

In one embodiment, the chip set or chip 900 includes a communication mechanism such as a bus 901 for passing information among the components of the chip set 900. A processor 903 has connectivity to the bus 901 to execute instructions and process information stored in, for example, a memory 905. The processor 903 may include one or more processing cores with each core configured to perform independently. A multi-core processor enables multiprocessing within a single physical package. Examples of a multi-core processor include two, four, eight, or greater numbers of processing cores. Alternatively or in addition, the processor 903 may include one or more microprocessors configured in tandem via the bus 901 to enable independent execution of instructions, pipelining, and multithreading. The processor 903 may also be accompanied with one or more specialized components to perform certain processing functions and tasks such as one or more digital signal processors (DSP) 907, or one or more application-specific integrated circuits (ASIC) 909. A DSP 907 typically is configured to process real-world signals (e.g., sound) in real time independently of the processor 903. Similarly, an ASIC 909 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 900 includes merely one or more processors and some software and/or firmware supporting and/or relating to and/or for the one or more processors.

The processor 903 and accompanying components have connectivity to the memory 905 via the bus 901. The memory 905 includes both dynamic memory (e.g., RAM, magnetic disk, writable optical disk, etc.) and static memory (e.g., ROM, CD-ROM, etc.) for storing executable instructions that when executed perform the inventive steps described herein to map a POI based on user-captured images. The memory 905 also stores the data associated with or generated by the execution of the inventive steps.

FIG. 10 is a diagram of exemplary components of a mobile terminal (e.g., handset) for communications, which is capable of operating in the system of FIG. 1A, according to one embodiment. In some embodiments, mobile terminal 1001, or a portion thereof, constitutes a means for performing one or more steps of mapping a POI based on user-captured images. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1003, a Digital Signal Processor (DSP) 1005, and a receiver/transmitter unit including a microphone gain control unit and a speaker gain control unit. A main display unit 1007 provides a display to the user in support of various applications and mobile terminal functions that perform or support the steps of POI mapping based on user-captured images. The display 1007 includes display circuitry configured to display at least a portion of a user interface of the mobile terminal (e.g., mobile telephone). Additionally, the display 1007 and display circuitry are configured to facilitate user control of at least some functions of the mobile terminal. An audio function circuitry 1009 includes a microphone 1011 and microphone amplifier that amplifies the speech signal output from the microphone 1011. The amplified speech signal output from the microphone 1011 is fed to a coder/decoder (CODEC) 1013.

A radio section 1015 amplifies power and converts frequency in order to communicate with a base station, which is included in a mobile communication system, via antenna 1017. The power amplifier (PA) 1019 and the transmitter/modulation circuitry are operationally responsive to the MCU 1003, with an output from the PA 1019 coupled to the duplexer 1021 or circulator or antenna switch, as known in the art. The PA 1019 also couples to a battery interface and power control unit 1020.

In use, a user of mobile terminal 1001 speaks into the microphone 1011 and his or her voice along with any detected background noise is converted into an analog voltage. The analog voltage is then converted into a digital signal through the Analog to Digital Converter (ADC) 1023. The control unit 1003 routes the digital signal into the DSP 1005 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1025 for compensation of any frequency-dependent impairments that occur during transmission though the air such as phase and amplitude distortion. After equalizing the bit stream, the modulator 1027 combines the signal with a RF signal generated in the RF interface 1029. The modulator 1027 generates a sine wave by way of frequency or phase modulation. In order to prepare the signal for transmission, an up-converter 1031 combines the sine wave output from the modulator 1027 with another sine wave generated by a synthesizer 1033 to achieve the desired frequency of transmission. The signal is then sent through a PA 1019 to increase the signal to an appropriate power level. In practical systems, the PA 1019 acts as a variable gain amplifier whose gain is controlled by the DSP 1005 from information received from a network base station. The signal is then filtered within the duplexer 1021 and optionally sent to an antenna coupler 1035 to match impedances to provide maximum power transfer. Finally, the signal is transmitted via antenna 1017 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1001 are received via antenna 1017 and immediately amplified by a low noise amplifier (LNA) 1037. A down-converter 1039 lowers the carrier frequency while the demodulator 1041 strips away the RF leaving only a digital bit stream. The signal then goes through the equalizer 1025 and is processed by the DSP 1005. A Digital to Analog Converter (DAC) 1043 converts the signal and the resulting output is transmitted to the user through the speaker 1045, all under control of a Main Control Unit (MCU) 1003 which can be implemented as a Central Processing Unit (CPU).

The MCU 1003 receives various signals including input signals from the keyboard 1047. The keyboard 1047 and/or the MCU 1003 in combination with other user input components (e.g., the microphone 1011) comprise a user interface circuitry for managing user input. The MCU 1003 runs a user interface software to facilitate user control of at least some functions of the mobile terminal 1001 to map a POI based on user-captured images. The MCU 1003 also delivers a display command and a switch command to the display 1007 and to the speech output switching controller, respectively. Further, the MCU 1003 exchanges information with the DSP 1005 and can access an optionally incorporated SIM card 1049 and a memory 1051. In addition, the MCU 1003 executes various control functions required of the terminal. The DSP 1005 may, depending upon the implementation, perform any of a variety of conventional digital processing functions on the voice signals. Additionally, DSP 1005 determines the background noise level of the local environment from the signals detected by microphone 1011 and sets the gain of microphone 1011 to a level selected to compensate for the natural tendency of the user of the mobile terminal 1001.

The CODEC 1013 includes the ADC 1023 and DAC 1043. The memory 1051 stores various data including call incoming tone data and is capable of storing other data including music data received via, e.g., the global Internet. The software module could reside in RAM memory, flash memory, registers, or any other form of writable storage medium known in the art. The memory device 1051 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1049 carries, for instance, important information, such as the cellular phone number, the carrier supplying service, subscription details, and security information. The SIM card 1049 serves primarily to identify the mobile terminal 1001 on a radio network. The card 1049 also contains a memory for storing a personal telephone number registry, text messages, and user specific mobile terminal settings.

Further, one or more camera sensors 1053 may be incorporated onto the mobile station 1001 wherein the one or more camera sensors may be placed at one or more locations on the mobile station. Generally, the camera sensors may be utilized to capture, record, and cause to store one or more still and/or moving images (e.g., videos, movies, etc.) which also may comprise audio recordings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising facilitating a processing of and/or processing (1) data and/or (2) information and/or (3) at least one signal, the (1) data and/or (2) information and/or (3) at least one signal based, at least in part, on the following:
a querying for one or more user-captured images based, at least in part, on a point-of-interest (POI) record;
a recognition of one or more identifying features of a POI associated with the POI data record in the one or more user-captured images;
at least one determination of a position of the of the one or more identifying features in the one or more user-captured images; and
a mapping of the POI based, at least in part, on the position of the one or more identifying features and image metadata associated with the one or more user-captured images.

2. A method of claim 1, wherein the (1) data and/or (2) information and/or (3) at least one signal are further based, at least in part, on the following:
an initiation of the querying, the recognition, the mapping, or a combination thereof based, at least in part, on a determination of one or more updates to the POI data record.

3. A method of claim 2, wherein the one or more updates comprise an addition, a modification, a deletion, or a combination thereof, of the POI data record.

4. A method of claim 1, wherein the (1) data and/or (2) information and/or (3) at least one signal are further based, at least in part, on the following:
an initiation of the querying, the recognition, the mapping, or a combination thereof based, at least in part, on a determination that the POI is potentially visible in a street level mapping view.

5. A method of claim 1, wherein the (1) data and/or (2) information and/or (3) at least one signal are further based, at least in part, on the following:
a processing of the image metadata to determine a location, a camera pose, or a combination of one or more cameras capturing the one or more user-captured images;
a correlation of the position of the one or more identifying features to one or more building models based, at least in part, on the location, the camera pose, or a combination thereof; and
at least one determination of the mapping of the POI based, at least in part, on the correlation.

6. A method of claim 1, wherein the one or more identifying features include, at least in part, one or more signs indicating a name, a symbol, a feature, or a combination thereof.

7. A method of claim 1, wherein the recognition of the one or more identifying features is based, at least in part, on an optical character recognition (OCR) process and/or an image matching process.

8. A method of claim 1, wherein the (1) data and/or (2) information and/or (3) at least one signal are further based, at least in part, on the following:
a comparison of the one or more identifying features against one or more reference identifying features stored in the POI data record to confirm the one or more identifying features.

9. A method of claim 1, wherein the (1) data and/or (2) information and/or (3) at least one signal are further based, at least in part, on the following:
at least one determination of a location, a time of release, or a combination thereof of the POI data record, the POI, or a combination thereof as one or more criteria for the querying.

10. A method of claim 1, wherein the mapping of the POI is based, at least in part, a global coordinate system.

11. An apparatus comprising:
at least one processor; and
at least one memory including computer program code for one or more programs,
the at least one memory and the computer program code configured to, with the at least one processor, cause the apparatus to perform at least the following,
cause, at least in part, a query for one or more user-captured images based, at least in part, on a point-of-interest (POI) record;
cause, at least in part, a recognition of one or more identifying features of a POI associated with the POI data record in the one or more user-captured images;
determine a position of the of the one or more identifying features in the one or more user-captured images; and
cause, at least in part, a mapping of the POI based, at least in part, on the position of the one or more identifying features and image metadata associated with the one or more user-captured images.

12. An apparatus of claim 11, wherein the apparatus is further caused to:
initiate the query, the recognition, the mapping, or a combination thereof based, at least in part, on a determination of one or more updates to the POI data record.

13. An apparatus of claim 12, wherein the one or more updates comprise an addition, a modification, a deletion, or a combination thereof, of the POI data record.

14. An apparatus of claim 11, wherein the apparatus is further caused to:
initiate the query, the recognition, the mapping, or a combination thereof based, at least in part, on a determination that the POI is potentially visible in a street level mapping view.

15. An apparatus of claim 11, wherein the apparatus is further caused to:
process and/or facilitate a processing of the image metadata to determine a location, a camera pose, or a combination of one or more cameras capturing the one or more user-captured images;
correlate the position of the one or more identifying features to one or more building models based, at least in part, on the location, the camera pose, or a combination thereof; and
determine the mapping of the POI based, at least in part, on the correlation.

16. An apparatus of claim 11, wherein the one or more identifying features include, at least in part, one or more signs indicating a name, a symbol, a feature, or a combination thereof.

17. An apparatus of claim 11, wherein the recognition of the one or more identifying features is based, at least in part, on an optical character recognition (OCR) process and/or an image matching process.

18. An apparatus of claim 11, wherein the apparatus is further caused to:
compare the one or more identifying features against one or more reference identifying features stored in the POI data record to confirm the one or more identifying features.

19. An apparatus of claim 11, wherein the apparatus is further caused to:
determine a location, a time of release, or a combination thereof of the POI data record, the POI, or a combination thereof as one or more criteria for the querying.

20. An apparatus of claim 11, wherein the mapping of the POI is based, at least in part, a global coordinate system.

21.-48. (canceled)
